(19) United States
(12) Patent Application Publication
(10) Pub. No.: US 2021/0094554 A1
(43) Pub. Date: Apr. 1, 2021

(54) VEHICLE-MOUNTED DEVICE AND FLEET MANAGEMENT SYSTEM

(71) Applicant: SOLID YEAR CO., LTD., New Taipei City (TW)

(72) Inventors: HUI-PING LIANG, Xiushui Township (TW); TSANG-LIN LIANG, Xiushui Township (TW)

(21) Appl. No.: 16/893,607

(22) Filed: Jun. 5, 2020

(30) Foreign Application Priority Data
Sep. 30, 2019 (TW) 108212943

(51) Int. Cl. B60W 40/09; G07C 5/08; G06K 9/00

(52) U.S. Cl. CPC B60W 40/09; G07C 5/0808; G06K 9/00845; B60W 2040/0872; G06K 9/00221; G06K 9/00597; G06K 9/00791

(57) ABSTRACT

A vehicle-mounted device and a fleet management system are disclosed. The vehicle-mounted device is mounted in a vehicle equipped with an OBD module that provides vehicle status parameters, including a sensor module mounted in the vehicle, a sensor module mounted in the vehicle and used to detect the real-time driving status image and driver status image of the vehicle, a general control module electrically connecting the sensor module and the OBD module for receiving the vehicle status parameters of the OBD module and the real-time driving status image and driver status image of the vehicle, and a judgment module electrically connected to the general control module to judge whether the driving of the vehicle complies with the driving specifications according to the data received by the general control module.

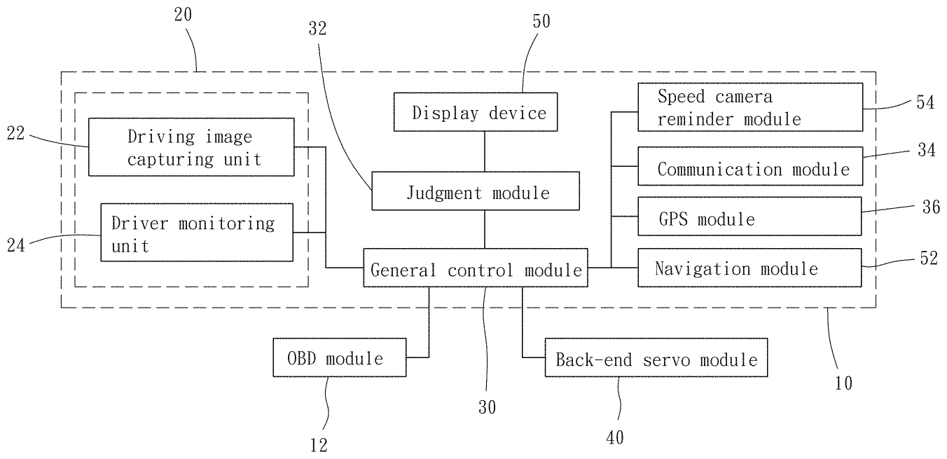

### BACKGROUND OF THE INVENTION

### 1. Field of the Invention

The present invention relates to vehicle technology and more particularly, to a vehicle-mounted device and a fleet management system.

### 2. Description of the Related Art

When the vehicle is driving, there will often be malfunctions or traffic accidents. Although family vehicles have been generally equipped with driving recorders to record the incident, in large vehicles, driving record paper cards are still used for recording vehicle status.

However, the above method of using the driving record paper card cannot be linked with the driving image to form useful interpretation information. Furthermore, the driving record paper card is easy to damage, so the record is not complete, and the accuracy is insufficient.

### SUMMARY OF THE INVENTION

The present invention has been accomplished under the circumstances in view. It is the main object of the present invention to provide a vehicle-mounted device and a fleet management system, which can more completely and accurately record driving data, improve the convenience of collecting the driving status of each vehicle, and make the fleet management more integrated and increase efficiency.

To achieve this and other objects, a vehicle-mounted device is mounted in a vehicle that is equipped with an OBD (On Board Diagnostic) module that provides vehicle status parameters. The vehicle-mounted device comprises a sensor module, a general control module, and a judgment module. The sensor module is mounted in the vehicle and used to detect the real-time driving status image and driver status image of the vehicle. The general control module electrically connects the sensor module and the OBD (On Board Diagnostic) module to receive the vehicle status parameters of the OBD (On Board Diagnostic) module and the real-time driving status image and driver status image of the vehicle. The judgment module is electrically connected to the general control module to judge whether the driving of the vehicle complies with the driving specifications according to the data received by the general control module. This can record driving data more completely and accurately, improve the convenience of collecting the driving status of the vehicle, and make the fleet management more integrated and increase efficiency.

Preferably, the general control module electrically connects a communication module that is used to transmit the vehicle status parameters, the real-time driving status image and the driver status image received by the general control module.

Preferably, the sensor module optionally comprises a driving image capturing unit or a driver monitoring unit. The driving image capturing unit is adapted to record the surrounding environment and road conditions of the vehicle. The driver monitoring unit is used to record the driver's body and driver's seat of the vehicle.

Preferably, the vehicle status parameters of the OBD (On Board Diagnostic) module include power system diagnostic data, intake system related parameters, exhaust system related parameters, engine speed, vehicle speed, fuel type, engine operating conditions, engine start time, control module voltage, brake related parameters, and fault related parameters.

Preferably, the judgment module comprises a personal identification unit that reads the driver's fingerprint, IC card, face or pupil physiological characteristics.

Preferably, the judgment module is equipped with an alcohol tester to obtain information about whether the driver has a drink, and then the judgment module confirms whether the driver meets the driving regulations and health regulations.

Preferably, the vehicle-mounted device further comprises a display device, through which the driver of the vehicle operates the vehicle-mounted device.

Preferably, the vehicle-mounted device further comprises a navigation module electrically connected to the general control module.

To achieve this and other objects, a fleet management system comprises the aforesaid vehicle-mounted device.

Preferably, the fleet management system further comprises a back-end servo module that receives and transmits data with the vehicle-mounted device.

The detailed structure or features provided by the present invention will be described in the subsequent detailed description of the preferred embodiment. However, those skilled in the art should be able to understand that this detailed description and the specific embodiment embodying the present invention are only used to illustrate the invention, not to limit the scope of protection of the claims of the invention.

### BRIEF DESCRIPTION OF THE DRAWINGS

The sole FIGURE is a system block diagram of the present invention.

### DETAILED DESCRIPTION OF THE INVENTION

The technical content and features of the present invention are described in detail below by listing preferred embodiments and drawings. The display device provided by the present invention can be widely used in various vehicles. Those skilled in the art can understand that the description language of this embodiment belongs to a general description that does not limit the application field. For example, the terms of materials or shapes include and are not limited to the materials or shapes specified in the description, and the terms of location include and are not limited to setting, approaching, connecting, or abutting. The number of elements “one” includes one and more than one number of elements. The directional adjectives mentioned in the content of this specification are only examples of description terms based on the normal direction of use, not intended to limit the scope of the claims.

Referring to the sole FIGURE, the invention provides a vehicle-mounted device 10 and a fleet management system using the vehicle-mounted device 10. The vehicle-mounted device 10 is installed in each vehicle of the fleet. Each vehicle has an OBD (On Board Diagnostic) module 12 that provides vehicle status parameters. The vehicle status parameters can be power system diagnostic data, such as intake system related parameters, exhaust system related parameters, engine speed, vehicle speed, fuel type, engine operating conditions, engine start time, control module voltage, brake related parameters, and fault related parameters, etc.

The vehicle-mounted device 10 comprises a sensor module 20, a general control module 30, and a judgment module 32. The sensor module 20 is used to obtain the real-time driving status image and the status of the driver of the vehicle. The sensor module 20 can optionally include a driving image capturing unit 22 or a driver monitoring unit 24. The driving image capturing unit 22 can optionally record the surrounding environment and road conditions of the vehicle with 4 lenses. The driver monitoring unit 24 can optionally use another lens to record the driver's body and driver's seat.

The general control module 30 electrically connects the sensor module 20 and the OBD module 12. The general control module 30 receives the vehicle status parameters of the OBD module 12, and the real-time driving status image and driver status image obtained by the sensor module 20. The general control module 30 can store the above vehicle status parameters in combination with real-time driving status image and driver status in the vehicle-mounted device 10. The general control module 30 can be electrically connected to a communication module 34. The communication module 34 can be a 4G or 5G communication unit. The communication module 34 is used to transmit all the data received by the general control module 30 to a back-end servo module 40 of the fleet management system.

The general control module 30 is additionally electrically connected to the judgment module 32. The judgment module 32 judges whether the driving of the vehicle complies with the driving specifications according to the above various parameters and images received by the general control module 30. For example, the judgment module 32 has a personal identification unit that reads the driver's fingerprint, IC card, face or pupil and other physiological characteristics to confirm whether the driver is the correct scheduled person. The judgment module 32 can also be equipped with an alcohol tester to obtain information about whether the driver has a drink, and then the judgment module 32 confirms whether the driver meets the driving regulations and health regulations. If the driver does not meet the driving regulations and health regulations, the general control module 30 can further control that the engine cannot start. The general control module 30 can also be electrically connected to a GPS module 36 to record the position of the vehicle at any time. In addition to allowing the fleet management system to collect the driving path of the vehicle, it can further plan the best fleet dispatching method and the use of returning vehicles.

With the above composition features, the vehicle-mounted device 10 can be directly connected to the vehicle's OBD (On Board Diagnostic) module 12, and the vehicle status parameters combined with the real-time driving status image and the driver status image can be stored in the vehicle-mounted device 10 or upload to the back-end servo module 40. All the operating status parameters of the vehicle during use, such as engine speed, vehicle speed, fuel inventory, braking and other parameters, can obtain matching driving images and driver images. Not only is the driving data record more complete and accurate, there is no need to use a driving record paper card. It improves the convenience of collecting the driving status of the vehicle, but also makes the fleet management more integrated and increases efficiency.

The vehicle-mounted device 10 additionally comprises a display device 50 electrically connected to the general control module 30. The display device 50 can be a flat screen for car, a touch screen, or a head-up display. The driver can obtain various vehicle status parameters, real-time driving status image and driver status from the display device 50. The driver can also optionally control the driving function through the display device 50. For example, the general control module 30 is electrically connected to a navigation module 52, and the driver can directly operate the navigation function from the display device. In addition, the general control module 30 can be electrically connected to a speed camera reminder module 54 so that the driver can receive a warning that there is a speed camera on the road ahead from the display device 50 or other warning device, and reduce the speed of the vehicle in advance to increase driving safety.

What is claimed is:

1. A vehicle-mounted device mounted in a vehicle that is equipped with an OBD (On Board Diagnostic) module that provides vehicle status parameters, said vehicle-mounted device comprising:
a sensor module mounted in said vehicle and used to detect the real-time driving status image and driver status image of said vehicle;
a general control module electrically connecting said sensor module and said OBD (On Board Diagnostic) module, said general control module receiving the vehicle status parameters of said OBD (On Board Diagnostic) module and the real-time driving status image and driver status image of said vehicle; and
a judgment module electrically connected to said general control module, said judgment module judging whether the driving of said vehicle complies with the driving specifications according to the data received by said general control module.

2. The vehicle-mounted device as claimed in claim 1, wherein said general control module electrically connects a communication module, said communication module being used to transmit said vehicle status parameters, said real-time driving status image and said driver status image received by said general control module.

3. The vehicle-mounted device as claimed in claim 1, wherein said sensor module optionally comprises a driving image capturing unit or a driver monitoring unit, said driving image capturing unit being adapted to record the surrounding environment and road conditions of said vehicle, said driver monitoring unit being used to record the driver's body and driver's seat of said vehicle.

4. The vehicle-mounted device as claimed in claim 1, wherein said vehicle status parameters of said OBD (On Board Diagnostic) module include power system diagnostic data, intake system related parameters, exhaust system related parameters, engine speed, vehicle speed, fuel type, engine operating conditions, engine start time, control module voltage, brake related parameters, and fault related parameters.

5. The vehicle-mounted device as claimed in claim 1, wherein said judgment module comprises a personal identification unit that reads the driver's fingerprint, IC card, face or pupil physiological characteristics.

6. The vehicle-mounted device as claimed in claim 1, wherein said judgment module is equipped with an alcohol tester to obtain information about whether the driver has a drink, and then the judgment module confirms whether the driver meets the driving regulations and health regulations.

7. The vehicle-mounted device as claimed in claim 1, further comprising a display device, through which the driver of said vehicle operates said vehicle-mounted device.

8. The vehicle-mounted device as claimed in claim 1, further comprising a navigation module electrically connected to said general control module.

9. A fleet management system, comprising a vehicle-mounted device as claimed in claim 1.

10. The fleet management system as claimed in claim 9, further comprising a back-end servo module that receives and transmits data with said vehicle-mounted device.
